(19) United States
(12) Patent Application Publication
(10) Pub. No.: US 2014/0320527 A1
(43) Pub. Date: Oct. 30, 2014

(54) HARDWARE GLYPH CACHE

(71) Applicant: MICROSOFT CORPORATION, REDMOND, WA (US)

(72) Inventors: MILES MARK COHEN, SEATTLE, WA (US); NIKLAS ERIK BORSON, LANGLEY, WA (US); WORACHAI CHAOWEERAPRASIT, BELLEVUE, WA (US)

(73) Assignee: MICROSOFT CORPORATION, REDMOND, WA (US)

(21) Appl. No.: 13/873,802

(22) Filed: Apr. 30, 2013

(51) Int. Cl. G06T 1/60; G06T 11/60

(52) U.S. Cl. CPC G06T 1/60; G06T 11/60
USPC 345/629; 345/557

(57) ABSTRACT

Methods, systems, and computer-storage media for performing a method of facilitating caching glyph data in hardware are provided. In embodiments, the method includes referencing a first glyph and a second glyph. Thereafter, a determination is made as to whether to merge the first glyph and the second glyph for rendering together as a set of merged glyphs. If it is determined to merge the first glyph and the second glyph, the merged glyph set including the first glyph and the second glyph are rendered. On the other hand, if it is determined to render the first glyph and the second glyph separately, glyph data associated with the first glyph that is in a hardware glyph cache and glyph data associated with the second glyph that is in the hardware glyph cache are used to render the first glyph and the second glyph separately.

### BACKGROUND

Traditionally, high-quality text rendering solutions cache glyph data in software memory processed by a central processing unit (CPU). In such implementations, the CPU performs a lot of processing to render each glyph run. For example, the CPU might identify glyph data in a font cache, compute glyph positions, clear space for the glyph run in an atlas, merge each glyph bitmap into an atlas, and transfer the glyph bitmaps to the graphics processing unit (GPU). During the merge step, glyphs may be positioned at subpixel offsets to allow for precise spacing between glyphs. Such processes are incurred each time glyphs are rendered even if the same glyphs are repetitively rendered. Further, transferring the glyph data to hardware memory can cause delays, particularly at higher dots per inch (DPI) where glyphs have more pixels.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention relate generally to facilitating caching glyphs in hardware. In this regard, cached glyphs can be processed by a graphics processing unit (GPU) enabling a more efficient glyph rendering. Embodiments of the present invention generate and utilize coverage indices associated with glyphs to individually render the glyphs. The coverage indices allow cached glyphs to be reused when rendering the glyphs at different subpixel offsets.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a block diagram of an exemplary computing system architecture suitable for use in implementing embodiments of the present invention;

FIG. 3 is a flow chart showing a method of facilitating caching a glyph in hardware, in accordance with an embodiment of the present invention;

FIG. 4 is a flow chart showing a first method of caching glyphs in hardware, in accordance with an embodiment of the present invention;

FIG. 5 is a flow chart showing a second method of caching glyphs in hardware, in accordance with an embodiment of the present invention; and

FIG. 6 is a flow chart showing a method of independently rendering a glyph using a glyph hardware cache, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate generally relate to facilitating caching glyphs in hardware. In this regard, glyphs can be cached in a hardware glyph cache and processed by computer processing unit (CPU) and/or a graphics processing unit (GPU) enabling a more efficient glyph rendering (e.g., reduces per-pixel processing). Embodiments of the present invention generate and utilize coverage indices associated with glyphs to individually render the glyphs. The coverage indices allow cached glyphs to be reused when rendering the glyphs at different subpixel offsets. In this way, when a cached glyph is to be rendered again, the glyph data already in the cache can be used rather than adding such data again thereby eliminating per-pixel CPU costs for glyphs that are already present in the hardware cache. Although generally described herein as rendering glyphs cached in a hardware cache using, at least in part, a GPU, other embodiments are intended to be included herein, such as, for instance, rendering glyphs on the CPU, using system memory used by the CPU and/or GPU, etc.

In one aspect, one or more computer-storage media having computer-executable instructions embodied thereon for performing a method of facilitating caching glyph data in hardware, the method comprising: referencing a first glyph and a second glyph; determining whether to merge the first glyph and the second glyph for rendering together as a set of merged glyphs, wherein when it is determined to merge the first glyph and the second glyph, the merged glyph set including the first glyph and the second glyph are rendered, and when it is determined to render the first glyph and the second glyph separately, using glyph data associated with the first glyph that is in a hardware glyph cache and glyph data associated with the second glyph that is in a hardware glyph cache to render the first glyph and the second glyph separately.

In another aspect, a method of facilitating caching glyph data is provided. The method includes obtaining one bit per pixel bitmap for the glyph, in accordance with a determination that glyph data associated with a glyph to be rendered is not in a glyph cache. The method also includes determining a coverage index for each pixel associated with the glyph, wherein each coverage index comprises a value that is used to identify a corresponding pixel coverage for any of a range of subpixel offsets. The method further includes caching the coverage indices associated with the glyph in the glyph cache.

In another aspect, a method implemented on a graphical processing unit (GPU) is provided. The method includes recognizing a desired glyph instance associated with a glyph in a hardware glyph cache. The method also includes referencing a set of coverage indices associated with the desired glyph instance, the set of coverage indices being cached in the hardware glyph cache. The method further includes using the set of coverage indices and a desired subpixel offset for rendering the glyph to determine, via a computing device, coverage values for the pixels associated with the glyph.

Having briefly described an overview of embodiments of the invention, an exemplary operating environment suitable for use in implementing embodiments of the invention is described below.

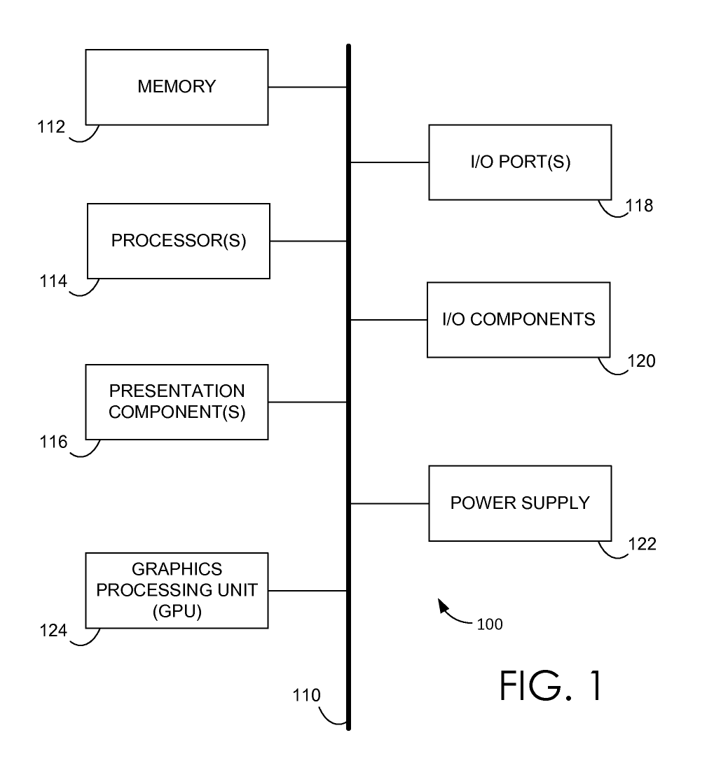

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, an illustrative power supply 122, and a graphical processing unit (GPU) 124. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, CPUs and GPUs have memory (e.g., independent memories or a shared memory). The diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-storage media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. As defined herein, computer storage media does not include communication media. Combinations of any of the above should also be included within the scope of computer-readable media.

Memory 112 includes computer-storage media in the form of volatile and/or nonvolatile memory. The memory 112 may be removable, non-removable, or a combination thereof. Exemplary memory includes solid-state memory, hard drives, optical-disc drives, etc. Although memory 112 is illustrated as a single component, as can be appreciated, a system memory used by the CPU and a separate video memory used by the GPU can be employed. In other implementations, a memory unit(s) can be used by both the CPU and the GPU.

Computing device 100 includes one or more processors 114 that read data from various entities such as bus 110, memory 112 or I/O components 120. As can be appreciated, the one or more processors 114 may comprise a central processing unit (CPU). Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

Components of the computing device 100 may be used in glyph rendering. For example, the computing device 100 may be used to implement a glyph rendering process that processes and applies various effects and adjustments to glyphs. Glyph rendering processes include a series of operations that are performed. These processes are generally designed to allow efficient processing of glyphs, while taking advantage of available hardware.

The graphics processing unit (GPU) 124 is a processing unit that facilitates graphics rendering. The GPU 124 can be used to render images, glyphs, animations and video for display on a display screen of a computing device. A GPU can be located, for example, on plug-in cards, in a chipset on the motherboard or in the same chip as the CPU. In embodiments, a GPU (e.g., on a video card) can include hardware memory or access hardware memory. In some implementations, a memory unit(s) that functions as both system memory (e.g., used by the CPU) and video memory (e.g., used by the GPU) can be employed. In other implementations, a memory unit that functions as system memory (e.g., used by the CPU) is separate from a memory unit that functions as video memory (e.g., used by the GPU). As can be appreciated, in some embodiments, the functionality of the GPU may be emulated by the CPU.

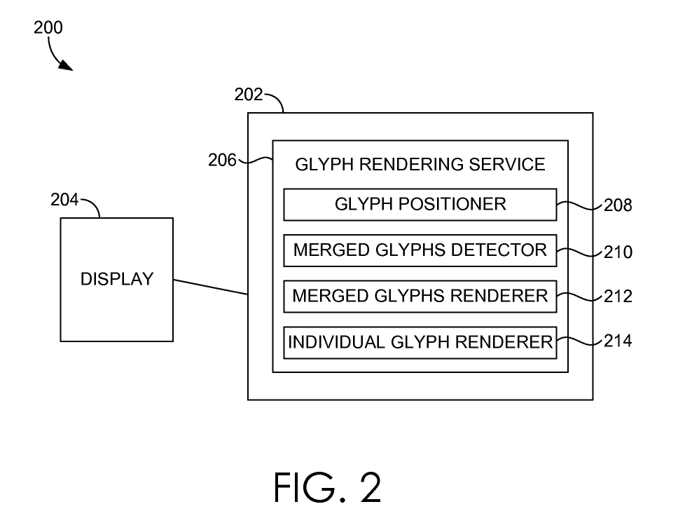

As previously set forth, embodiments of the present invention relate to computing systems for facilitating caching glyph data in hardware. With reference to FIG. 2, a block diagram is illustrated that shows an exemplary computing system architecture 200 suitable for use with facilitating caching glyph data in hardware. The computing system architecture 200 shown in FIG. 2 is merely an example of one suitable computing system and does not limit the scope of use or functionality of the present invention. Neither should the computing system architecture 200 be interpreted as having any dependency or requirement related to any single module/component or combination of modules/components.

Computing system architecture 200 includes computing device 202 and display 204. Computing device 202 may be any type of computing device, such as, for example, computing device 100 described above with reference to FIG. 1. By way of example only and not limitation, computing device 202 may be a personal computer, desktop computer, laptop computer, handheld device, mobile handset, consumer electronic device, or the like.

Computing device 202 comprises a glyph rendering service 206. The glyph rendering service 206 is a service directed to rendering glyphs. In embodiments, the glyph rendering service 206 includes a glyph positioner 208, a merged glyphs detector 210, a merged glyph renderer 212, and an individual glyph renderer 214. The glyph rendering service 206 can be associated with any number of components and is not intended to be limited to those illustrated in FIG. 2. Further, such component, and/or functions described herein, can be performed by a CPU, a GPU, or a combination thereof.

The glyph rendering service 206, or a portion(s) thereof, can be associated with an operating system of a computing device such that the service can be utilized to perform glyph rendering for multiple applications and processes of the computing device. Alternatively or additionally, the glyph rendering service 206, or a portion(s) thereof, can be associated with an application running on the computing device such that the service can be used to perform glyph rendering for that particular application or process of the computing device. The glyph rendering service 206 can be used to analyze any glyphs to be rendered, such as, for example, text that is being presented on the screen in association with a user viewing a document, a spreadsheet, a web page, etc. or text that is being presented on the screen in association with a user typing or otherwise indicating text to be input or presented.

In accordance with identifying glyphs to be rendered, the glyph positioner 208 is configured to identify glyph positioning. In this regard, the glyph positioner 208 may determine a position for each glyph on a render target. A glyph refers to a specific shape, design, or representation of a character. In this way, a glyph can be a graphical representation of an element of a written language (e.g., in a particular typeface or font). A character or element might be text, symbols, or the like.

The merged glyphs detector 210 is configured to detect whether glyphs should be merged together. In this regard, the merged glyphs detector 210 assesses whether glyphs should be rendered individually or rendered as a glyph set of two or more glyphs. To efficiently cache glyph data in hardware, it is desirable to render glyphs independently or separately (e.g., without merging one bit per pixel bitmaps in advance). However, because rendering glyphs separately can produce different visual results, merge detection is utilized to determine which glyphs can be rendered separately (using the glyph cache) and which glyphs should be merged.

By way of example only, assume that a first glyph representing a “T” and a second glyph representing an “H” partially overlap the same pixel. Further assume that the pixel's coverage for the first glyph is determined to be 50% covering the left half of the pixel, and the pixel's coverage for the second glyph is also determined to be 50% covering the right half of the same pixel. If the “T” and the “H” are rendered one at a time, the rendering of the two partial coverages on top of one another provides a dark gray, but not a black coverage value (i.e., 100%), which may impact readability.

Initially, the merged glyphs detector 210 references or obtains a glyph run(s) or a set of glyphs. A glyph run refers to a series of glyphs. A glyph run may be a set of characters all in the same font, color, size, and/or style. In some embodiments, a glyph run might include all glyphs, or a portion of glyphs, to be rendered in association with an application, document, webpage, etc.

Upon referencing or obtaining glyphs to be analyzed, the merged glyphs detector 210 can determine or identify which, if any, glyphs to merge together as a glyph set for rendering. Any manner or number of manners can be utilized to perform such a detection. Further, any number of glyphs might be merged together as a glyph set. For example, in some cases, two glyphs might be merged together as a glyph set and, in other cases, three glyphs might be merged together as a glyph set. In some cases, a default might exist such that glyphs are never merged. In such a case, merge detection may be omitted and glyphs would be automatically rendered independently.

In one embodiment, the merged glyphs detector 210 can use a bounding detection to identify glyphs that can be rendered separately and/or glyphs that should be merged together for rendering. In such an implementation, a boundary, such as a bounding box (e.g., rectangle), can be positioned around the glyphs. For example, a bounding box may be a rectangle that borders the horizontal and vertical portions of a glyph. Upon placing or positioning a boundary around the glyphs, it can be determined or detected whether the boundaries are within a threshold distance from one another. If boundaries fall within a threshold distance from one another, the corresponding glyphs are deemed or designated to be merged and rendered as a merged glyph set. By contrast, if the boundaries are not within a threshold distance from one another, the glyphs are rendered independently or separately. Such a threshold distance can be any distance. For example, in some embodiments, the threshold distance may be that the boundaries are touching or intersect with one another. In this way, when glyphs overlap or touch one another, the glyphs are merged. In another embodiment, the threshold distance might be one pixel or one subpixel. In this case, if the glyphs are within one pixel or one subpixel from one another, the glyphs are merged for rendering.

By way of example only, assume that a threshold distance of one subpixel exists and that a first bounding box can be positioned or placed around a letter T, and a second bounding box can be positioned or placed around a subsequent letter H. Now assume that it is detected that the T and the H are separated by two subpixels. In this regard, the letters T and H can be determined or identified to be rendered separately.

In an alternative or additional embodiment, the merged glyphs detector 210 can use one or more font rules to determine whether to merge glyphs for rendering. A font rule can be any type of rule particular to a font that indicates whether two or more glyphs should be merged together for rendering. In this way, a font designer, for example, can set or establish rules for which glyph combinations should be merged and/or which can be rendered independently. Utilizing font rules for a corresponding font can enable the rendering code to use an optimal rendering designed for the font. In some cases, a font might be designed in such a way that the font designer can indicate that no glyphs need to be merged, for instance, even if there are rendering differences based on whether glyphs are merged. Other fonts may have some glyph combinations that require merging and some glyph combinations that do not require merging.

Font rules can be based on any criteria. In some embodiments, a font rule(s) might be based on the particular glyphs being analyzed. For instance, in font A, the letters T and R next to one another can be identified as requiring a glyph merge. In other embodiments, the font rules might be based on one or more classifications associated with the glyphs. A glyph classification might be, for example, an indication of whether the glyph is a capitalized glyph or lower-case glyph; a language associated with a glyph (e.g., English, Arabic, Spanish, German, Chinese, etc.); an indication of whether the glyph is a numerical character, an alphabetical character, a symbol, or the like; etc. For instance, for a particular font B, all English glyphs might be identified as falling into Class 0 within which no glyphs need to be merged. For the same font B, Arabic glyphs might be identified as falling into Class 1, and a corresponding font rule may indicate that two Class 1 glyphs next to one another should be merged together. As can be appreciated, font rules, criteria, and/or glyph classifications can be specific to a particular font style and thereby provide a more accurate glyph rendering for the particular font.

In some cases, font rules, font criteria, and/or font classifications may be indicated in a merge table or index. A merged table or index might be created by a font designer, an operating system developer, a program developer, etc. The merged glyphs detector 210 can access a merge table associated with a particular font style to make a determination of whether to render glyphs together or separately from one another. Such a merge table can be stored in any location, such as, for example, at a location local to or remote from the computing device or at the computing device in a location that is local to or remote from the merged glyphs detector 210 and/or the glyph rendering service 204. In some cases, if a font does not have a merge table or other indication of font rules, font criteria, and/or font classifications, a default action may be utilized. For example, a default of merging glyphs might be employed or a default of utilizing a boundary detection implementation might be employed in cases that an applicable font rule is not applicable.

By way of example only, and without limitation, a merge table associated with a particular font style might have two components, a font classification table and a font rule table. The classification table might include each glyph, or an indication thereof, and an indication of a merge class. As previously described, the merge class can be associated with any glyph attributes, such as lower-case, upper-case, language type, combinations thereof, or the like. In some cases, any glyph not explicitly mapped to a particular merge class might be assigned a default class, such as Class 0. The rule table might include a two-dimensional array that maps each pair of merge classes to a merge rule or behavior (e.g., merge corresponding glyphs for rendering, render glyphs separately, etc.).

In implementation, to determine glyphs in a particular glyph run to merge as a glyph set, the merged glyphs detector 210 might scan the glyph run from beginning to end in logical order. With each iteration, the merge class of the next glyph might be looked up or identified. The current glyph class(es) and the next glyph class can then be used in connection with the appropriate merge rule to determine whether a glyph merge is to occur.

Upon determining glyphs to merge or render separately, an appropriate rendering process can be applied accordingly. For instance, merged glyph sets to render, or an indication thereof, can be provided to the merged glyph renderer 212 for rendering, and glyphs to be independently rendered, or an indication thereof, can be provided to the individual glyph renderer 214 for rendering. Although the merged glyph renderer 212 and the individual glyph renderer 214 are illustrated as two separate components, the functionality provided therein can be combined into a single component or performed by any number of components.

The merged glyph renderer 212 is configured to facilitate rendering merged glyph sets. As previously described, a merged glyph set refers to a set of glyphs that are merged together to be rendered as a single unit. For a merged glyph set (i.e., merged glyphs), space can be allocated within a merge bitmap. In this regard, different parts of a merge bitmap might be used for different glyphs. A merge bitmap is a one bit per pixel (bpp) bitmap that contains raster representations of glyphs within the merged glyph set. Each pixel in the merge bitmap is either a 1 indicating coverage by a glyph or a 0 indicating lack of coverage by a glyph. The glyph rasterizations in the merge bitmap may be overscaled compared to the size on the final target thereby allowing for antialiasing and/or subpixel positioning. A subpixel refers to a portion of a pixel. Subpixel positioning or offsetting refers to the capability to position a glyph within a pixel via subpixel locations or offset a glyph from the beginning of a pixel using subpixel locations. As can be appreciated, in some implementations, to increase efficiency, a large bitmap, such as texture atlas, can be created and space can be allocated therein for the individual merge bitmaps.

For each glyph in a merged glyph set, the merged glyph renderer 212 can obtain a rasterized glyph. A rasterized glyph refers to one bit per pixel (bpp) bitmap representing the glyph. As can be appreciated, a rasterized glyph may be created through a rasterization process. In some implementations, such a rasterized glyph might come from a font cache. Accordingly, such glyph data might be looked up or referenced from a font cache. Such a font cache may reside in CPU memory and be distinct from the hardware glyph cache described herein. Upon obtaining the one bit per pixel rasterization of the glyph, the rasterized glyph is rendered to its location within the merged bitmap, for example, using bitwise operation (e.g., bitwise OR operation). The glyph can be positioned using subpixels, for example, when the one bpp rasterizations are overscaled compared to the size on the final target. For example, assume that an overscale factor of eight is employed. In such a case, a glyph can be positioned to the nearest ⅛ pixel by shifting the overscale.

For the merged glyph set, the merged bitmap can be filtered producing a coverage value for each pixel on the final render target. The coverage value can be obtained for each pixel, for instance, by counting or identifying the number of covered overscale bits for each pixel and dividing by the total possible coverage. For example, if the overscale factor is 4×4, each pixel would correspond to 16 one bit per pixels within the merged bitmap. To calculate coverage, the number of the one bit per pixels associated with a “1” would be determined and divided by 16 to produce a coverage value between 0 and 1.

The merged glyph renderer 212 can also be configured to perform coverage adjustments, such as enhanced contrast or alpha correction, to produce an adjusted coverage per pixel. Such adjusted coverage values can be used as a coverage mask to blend a glyph to the target. For example, if a glyph is rendered with simple source-over-blending and the foreground color is opaque, then an adjusted coverage can be used to blend the glyph to the target. In this way, if the adjusted coverage is 0, then the background color is used for that pixel. If the adjusted coverage is between 0 and 1, then the foreground color is blended with the background color using the adjusted coverage to interpolate between the two colors.

As can be appreciated, in some embodiments, merged glyphs can be cached such that the merged glyph set can be subsequently referenced for later use. In this regard, glyphset data can be cached and, thereafter, referenced when the glyph set is subsequently used to render the merged glyph set. In such a case, when the desired merged glyphset data is cached, such data can be used for rendering the glyph set.

The glyphs produced or rendered by the merged glyph renderer 212 may be provided, for example, for display via the display 204 associated with the computing device 202. In this regard, the final colored pixels can be displayed on a computer monitor or otherwise presented or provided. For instance, a rendering result can be stored as a bitmap file, printed on a page, displayed on a display screen, or the like.

Turning to the individual glyph renderer 214, the individual glyph renderer 214 is configured to facilitate rendering glyphs independently. As such, upon determining that a particular glyph(s) is to be rendered independently (e.g., at merged glyphs detector 210), the glyph can be rendered in accordance with the functionality described herein in association with the individual glyph renderer 214. In some implementations, a sequence of merged glyphs might be treated collectively, as if it were a single composite glyph, and render is using the individual glyph renderer 214. In such a case, the identity of the sequence might incorporate the identity of the component glyphs and the spacing between such glyphs.

Initially, the individual glyph renderer 214 can determine whether glyph data associated with a particular glyph to be rendered exists in a glyph cache (e.g., a hardware glyph cache). In this way, the glyph cache may be accessed to identify if the desired glyph data is in the glyph cache. Glyph data, as used herein, can refer to any data describing, indicating, or representing a glyph. In embodiments, glyph data may be a glyph (or representation thereof), a coverage index, coverage indices, or the like.

In some implementations, to determine if glyph data associated with a desired or particular glyph is in the glyph cache (e.g., hardware glyph cache), a glyph identifier might be used to identify whether such a glyph, or data corresponding therewith, is cached in hardware memory. In some cases, a determination can be made as to whether glyph data is cached that is associated with a particular glyph instance. In this regard, a determination is made as to whether a particular instance of the glyph exists in the cache. As described below, in some cases, glyph data, such as coverage indices, associated with a particular glyph may vary. As such, a particular glyph might be associated with different sets of glyph data and thereby utilize different glyph instances to provide the different sets of glyph data. A glyph instance might be uniquely identified, for instance, using the corresponding font, size, a subpixel offset, and/or identifier of the glyph within the font. For a merged glyph set, the identity of a glyph instance might include identifiers associated with each glyph in the glyph set. A glyph instance can refer to a key composed of one or more of font, font style, point size, scale factor, rotation, rendering mode (e.g., includes overscale factor), glyph identifier, subpixel position classification (e.g., for 8×1, the subpixel classification could be classified as 0-3 or 4-7).

By way of example only, and without limitation, a first set of glyph data (e.g., coverage indices) associated with a particular glyph can be represented by a first glyph instance or version, and a second set of glyph data (e.g., coverage indices) associated with the same glyph can be represented by a second glyph instance or version. Each of the different cached versions or instances can be associated with different coverage indices. In this way, the first set of glyph data might include coverage indices that are utilized for subpixel offset positions 0-3, while the second set of glyph data might include coverage indices that are utilized for subpixel offset positions 4-7, for instance in a 8×1 text. Now assume that the glyph is to be rendered having a subpixel offset of 2, that is, shifted over two subpixels. As the first glyph instance is associated with subpixel offset positions 0-3, the cache can be referenced to identify if it contains the first glyph instance. By comparison, if the glyph is to be rendered at a subpixel position of 7, a determination is made as to whether the second glyph instance is cached.

As described, to determine which particular glyph instance is desired, the subpixel offset at which to render the glyph can be used. The intended subpixel offset might be identified or calculated based on the glyph layout. By way of example, during the glyph layout process, the position of a glyph might be determined to be at 10.4 units. The fractional portion of the position (i.e., 0.4 in horizontal direction) can be used to determine the subpixel offset. For instance, assume that an 8×1 text mode is employed, and the fractional portion is 0.4. The supbixel offset is can be determined by multiplying 0.4 times 8 and rounding to the nearest integer (i.e., subpixel position 3). As such, the glyph can be rendered at pixel 10 with a subpixel offset of 3. Because subpixel position 3 has been identified, a determination can be made as to whether the first glyph instance corresponding with subpixel positions 0-3 exists in the cache. If so, the glyph data associated with the first glyph instance can be referenced and utilized to render the glyph, as described more fully below.

In implementation, to determine whether a glyph or glyph instance is cached, the glyph cache can use a process, such as a hash table lookup, to identify the glyph instance that corresponds to the given set of properties. Once identified, the glyph instance can specify the location (e.g., a bitmap or part of a bitmap, such as part of an atlas texture) of the corresponding glyph data. By way of example only, a multilevel hashtable might be used to select the correct glyph instance within the cache. The first level of hash might be composed of the font/scale factor and rotation. The second level of the hash might be the glyph identifier, and the third level of the hash might be the subpixel position classification.

If it is determined that glyph data associated with a desired glyph and/or glyph instance is in the glyph cache (e.g., hardware glyph cache), the individual glyph renderer 214 can facilitate rendering the glyph. In this regard, coverage values for pixels associated with a particular glyph having a subpixel offset (e.g., including a subpixel offset of zero) can be identified. In some cases, such processing might be performed by the GPU.

To identify or determine coverage values for pixels associated with a glyph, the coverage indices associated with the pixels are referenced. For example, the coverage indices can be identified via the glyph data in the cache associated with a desired glyph or glyph instance (e.g., as identified by a desired subpixel offset). The coverage indices in association with the appropriate subpixel offset value can be used to determine the coverage value for the pixels. By way of example only, a lookup of a coverage index in the column of the table and subpixel offset in the row of the table can be used to identify the corresponding coverage value. That is, the coverage index in combination with the subpixel offset enables identification of a corresponding coverage value for a particular pixel.

Upon obtaining the coverage values associated with the pixels of the glyph, the coverages can be adjusted and/or blended to appropriately render the glyph. Coverage might be adjusted, for example, to make the text appear more bold such that, for example, the edges appear sharper or to compensate for the gamma correction. In some embodiments, coverage adjustments might be performed by the process that generates the table such that the obtained coverage value is already adjusted and further table lookup is not required. Blending facilitates blending with the foreground and/or background. In this regard, the foreground coloring of the text (e.g., black) and the background. If a pixel is associated with 75% coverage, the final color of that pixel might be 25% of background color plus 75% of the foreground color.

The glyphs produced or rendered by the individual glyph renderer 214 may be provided, for example, for display via the display 204 associated with the computing device 202. In this regard, the final colored pixels can be displayed on a computer monitor or otherwise presented or provided. For instance, a rendering result can be stored as a bitmap file, printed on a page, displayed on a display screen, or the like.

If it is determined that glyph data associated with a desired glyph and/or glyph instance is not in the glyph cache (e.g., hardware glyph cache), the individual glyph renderer 214 can facilitate caching glyph data as well as rendering the glyph. Initially, to cache glyph data, a rasterized glyph is obtained, that is, a one bit per pixel raster image or bitmap for the glyph is obtained. As one bit is indicated for each pixel of the glyph, each bit value can be, for example, a 1 to indicate an opaque rendering (e.g., black, that is, the pixel or subpixel is fully covered by the glyph) or a 0 to indicate a transparent rendering (e.g., white, that is, the pixel or subpixel is not covered by the glyph). As such, such a bitmap may be a black and/or white glyph without smooth edges if rendered on a display. As can be appreciated, any number of pixels and corresponding bits might be associated with glyphs, but each pixel has only one bit. The rasterized glyphs may be overscaled, for instance, to facilitate antialiasing. In this way, the glyph can be rasterized at a higher resolution than it will actually be rendered on the display. In such cases, each pixel of the rasterized glyph is actually a subpixel, with multiple subpixels for each pixel of the cached glyph. In some cases, the one bit per pixel bitmap is an initial glyph without any subpixel offset. A rasterized glyph can be obtained in any number of manners or methods. In some implementations, a rasterized glyph is obtained from a font rasterization process, for example, that computes a one bit per pixel bitmap from a vector representation of the shape of the glyph.

Upon obtaining a rasterized glyph or one bit per pixel bitmap for a glyph, coverage indices for each pixel in the glyph can be computed. A coverage index is a value associated with a pixel that can be used to identify a coverage for a given pixel for any of a range of multiple subpixel offsets. Stated differently, a coverage index is a value associated with a set of coverage values for different subpixel offsets or shifts. For example, a coverage index is a computed value that can enable identification of the coverage for a given pixel for any of subpixel offsets or positions 0-7. As another example, a coverage index is a computed value that can enable identification of the coverage for a given pixel for any of subpixel offsets or positions 0-3 and another coverage index is computed to identify coverage for a given pixel for any of subpixel offsets or positions 4-7. In some cases, coverage indices may not be computed. For example, if antialiasing is not required or used, the cached glyph data can be the same as the rasterized glyph, with one bit for each pixel. As another example, if antialiasing is required or used but not subpixel positioning, the cached glyph data could just be a coverage value rather than a coverage index.

A coverage index is capable of simultaneously storing or encoding coverage for multiple subpixel shifts based on redundant data between coverage values of neighboring subpixel offsets. For example, for 8×1 text, if the coverage for subpixel shift zero is five, then the coverage for subpixel shift one must be either four, five, or six as subpixel one shares all but one bit with subpixel shift zero. As such, to store coverage values for both subpixel shift one and subpixel shift two, nine times three values (rather than nine times nine values) are sufficient to represent this information. As such, four coverage values corresponding with four different subpixel positions can be stored in one byte (9×3×3×3=243, which is less than 255). Similarly, for 4×4 text, two coverage values can be stored in the same byte. As four coverage values for a pixel can be stored into one coverage index for 8×1 text, only two instances of the glyph need to be stored in the cache (i.e., one for subpixel shifts 0-3 and one for shifts 4-7).

A coverage index for a particular pixel can be computed in any number of ways. For example, in one embodiment, to identify a coverage index for a particular pixel, a lookup table can be accessed to convert from overscale data to a coverage index. Such a conversion or calculation may be performed by the CPU and/or the GPU. The coverage index for each pixel associated with a glyph, or a boundary associated therewith, can be combined into a set of coverage indices or a coverage indices bitmap.

By way of example only, coverage indices can be computed by initially emptying a hashtable and initializing the largestCoverageIndex value to 0. For each possible value of the overscale data that can have an influence over the coverage for the set of subpixel positions of interest (e.g., a number between 0 and 2̂(8+3)−1 when dealing with 8×1 text). The eight is the number of bits needed for one coverage value, and the extra three bits of input data are for three neighboring values so that the coverage index can be used for four subpixel positions. The coverage for all subpixel positions of interest can be computed (e.g., 4 in the case of 8×1), and the four coverage values can be combined together to form a coverage combination, which can be used as a key value in the hashtable. The hashtable can be used to identify if the key is already present. If the key is not present, the largestCoverageIndex is incremented and stored in the hashtable using the key. If, however, the key is present, the key is used to obtain the index that represents the coverageIndex for the given overscale value, so it can be added to the overscaleToCoverageIndex table. After all overscale values have been processed, the data in the hashtable can be looped through, sorting by coverageIndex. For each coverageIndex, the key value is used to obtain the coverageCombo. The coverageCombo can be used to identify the coverage for a given subpixel value. Using this process, one table for each subpixel value can be attained and used to get from a coverageIndex value to a coverage value.

Upon computing coverage indices associated with a glyph and/or a glyph instance, glyph data, such as the glyph and/or corresponding coverage indices, can be cached in the glyph cache (e.g., hardware glyph cache). In some embodiments, even though a particular subpixel offset may be needed to render for a glyph or glyph instance not previously cached, the coverage indices and/or coverage values may be computed for each of the subpixel offsets (e.g., 4, 8, 16) for the particular glyph or glyph instance such that the glyph data can be cached for subsequent utilization. In this way, when a glyph instance is cached to render the glyph at a given subpixel position, the same glyph instance may be used to later render the glyph at a different subpixel position.

Upon identifying glyph data to be stored in a glyph cache (e.g., glyph, coverage indices associated with the glyph or glyph instance, coverage values, etc.), the individual glyph renderer 214 can facilitate caching the glyph data. As the size of the glyph cache (e.g., hardware glyph cache) is limited, the individual glyph renderer 214 can assess and determine which glyph data to keep, maintain, or add to the cache and which glyph data to dispose. For example, as font sizes and/or font styles change, glyphs are added to the cache. As another example, in some languages, different glyphs exist for many words in the language resulting in more glyphs being cached in the glyph cache (e.g., hardware glyph cache).

In one implementation, a short-lived partition of a cache and a long-lived partition of the cache are used to manage the glyph data. A short-lived partition of a cache includes a portion of the cache that contains glyph data that is cached for a shorter period of time than the data cached in the long-lived partition. Data in the short-lived partition might be discarded (e.g., in entirety or in part) upon a lapse of a period of time, upon utilizing all the space within the short-lived partition, etc. The long-lived partition of the cache includes a portion of the cache that contains glyph data that is cached for a longer period of time than the data cached in the short-lived partition. The long-lived partition might contain glyph data associated with glyphs or glyph instances recognized as having high rendering frequency when stored in the short-lived partition (e.g., before being evicted from the short-lived partition). Data in the long-lived partition might be discarded (e.g., in entirety or in part) upon a lapse of a period of time, upon utilizing all the space within the long-lived partition, etc.

Generally, glyph data is placed in the short-lived partition or the long-lived partition based on the frequency of rendering the glyph or glyph instance. That is, frequently used glyphs or glyph instances are placed in the long-lived partition, while infrequently used glyphs or glyph instances are placed in the short-lived partition. As the cache is partitioned, the partitions can overflow independently of one another. As such, when the short-lived partition overflows, the long-lived partition can remain intact (and vice-versa). Although described as having two partitions, any number of cache partitions can be used for storing glyph data within the cache.

In embodiments, new glyph data associated with a particular glyph or glyph instance to be added to the cache is initially added to the short-lived partition. The short-lived partition of the cache continues to collect and retain glyph data. Upon reaching capacity or fulfillment of the short-lived partition of the cache, the glyph data therein is discarded (e.g., all glyph data). Glyph data associated with glyphs or glyph instances rendered more frequently can be cached in the long-lived partition of the cache. Such a determination can be based on any frequency data. For example, a glyph can be designated as being rendered at a high frequency when the frequency exceeds a threshold, such as, for example, a predetermined numeral, an average frequency, a median frequency, etc. By way of example only, glyphs might be considered to be of high frequency if the usage count (e.g., number of times rendered) is greater than average during the lifetime of the short-lived partition prior to discarding data based on an overflow. In another case, a glyph can be designated as being rendered at a high frequency when the predetermined character frequency is above a threshold amount. For instance, the relative frequency of letters in the English alphabet is well-known.

In some cases, in accordance with discarding glyph data from the short-lived partition, glyph data associated with a glyph(s) or a glyph instance(s) deemed to have a relatively high frequency can be transmitted or provided to the long-lived partition. In other cases, glyphs or glyph instances deemed to have a relatively high frequency can be indicated or identified as such and, thereafter, upon an initial rendering following the overflow discard, the glyph data associated therewith can be cached in the long-lived partition. In such cases, a glyph must be rendered again after being evicted from the short-lived partition before being placed in the long-lived partition. Similarly, glyph data can be discarded from a long-lived partition. In some cases, once glyphs are evicted from the long-lived partition (e.g., upon filling the long-lived partition), such glyphs may not be placed back in the long-lived partition the next time they are rendered. Rather, frequency data may be analyzed to determine in which partition the glyph will later be placed.

To indicate or identify that a glyph was identified as high frequency, a frequency bit or other indicator can be stored for such glyphs. For example, a frequency bit can stored within a table for subsequent reference. Such a frequency bit might indicate the rendering frequency or simply that a particular glyph/glyph instances is rendered frequently. In addition to tracking the number of times a glyph or glyph instance is rendered, a total number of times that all glyphs or glyph instances, for example, in the short-lived partition are rendered can be tracked. As such, high frequency glyphs can be identified by comparing the number of times the glyph was rendered to the average number of times all glyphs were rendered (e.g., within a particular period of time). In this example, if the glyph was not rendered more than the average number of times, the next time it is rendered, glyph data will be placed in the short-lived cache. By contrast, if the glyph was rendered more than the average number of times, a bit indicator is generated so that next time the glyph is rendered, the glyph data is placed in the long-lived partition.

To facilitate rendering glyphs, the individual glyph renderer 214 can identify coverage values prior to or subsequent to caching hardware glyph data. In some cases, such analysis might be performed prior to caching the hardware glyph. In other cases, such analysis might be performed after the hardware glyph data is cached. In such cases, the cached data might be utilized to identify the coverage values. For example, in cases that a desired glyph or glyph data is not recognized in the cache, glyph data is generated and appropriately stored in the cache. Thereafter, the glyph data can be used to render the glyph.

In embodiments, coverage values for pixels associated with a particular glyph having a subpixel offset (e.g., including a subpixel offset of zero) can be identified. In some cases, such processing might be performed by the GPU.

To identify or determine coverage values for pixels associated with a glyph, the coverage indices associated with the pixels are referenced. For example, the coverage indices can be identified via the glyph data in the cache associated with a desired glyph or glyph instance (e.g., as identified by a desired subpixel offset). The coverage indices in association with the appropriate subpixel offset value can be used to determine the coverage value for the pixels. By way of example only, a lookup of a coverage index in the column of the table and subpixel offset in the row of the table can be used to identify the corresponding coverage value. That is, the coverage index in combination with the subpixel offset enables identification of a corresponding coverage value for a particular pixel.

Upon obtaining the coverage values associated with the pixels of the glyph, the coverages can be adjusted and/or blended to appropriately render the glyph. Coverage might be adjusted, for example, to make the text appear more bold such that, for example, the edges appear sharper or to compensate for the gamma correction. Blending facilitates blending with the foreground and/or background. In this regard, the foreground coloring of the text (e.g., black) and the background. If a pixel is associated with 75% coverage, the final color of that pixel might be 25% of background color plus 75% of the foreground color.

The glyphs produced or rendered by the individual glyph renderer 214 may be provided for display via the display 204 associated with the computing device 202. In this regard, the final colored pixels can be displayed on a computer monitor or other display.

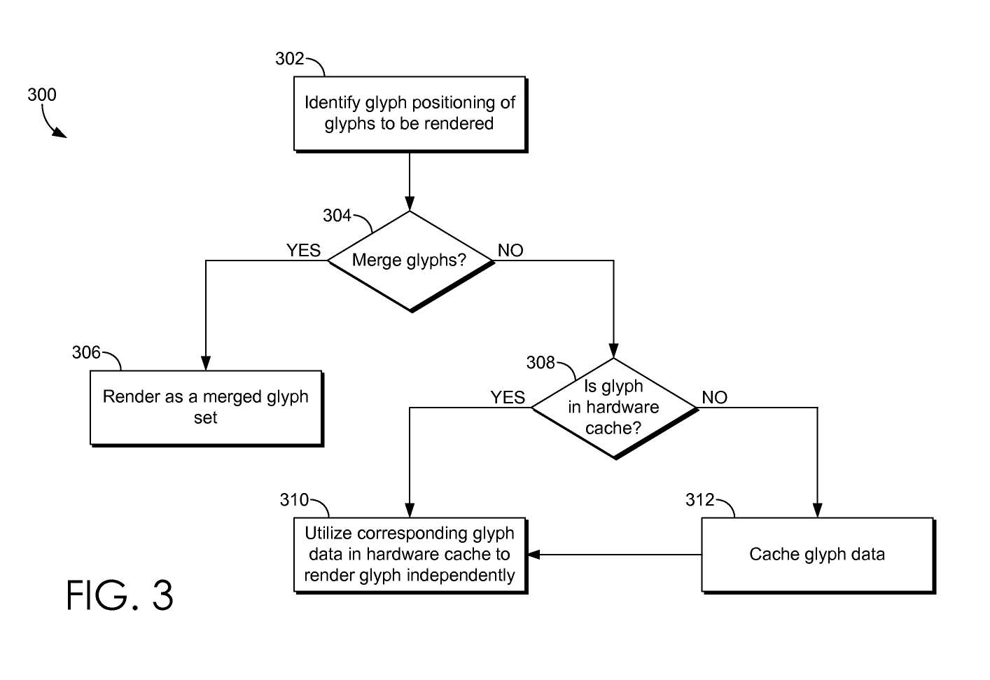

Turning now to FIG. 3, a method 300 of facilitating caching a glyph in hardware is described, in accordance with an embodiment of the present invention. Such a method may be performed at a computing device.

Initially, as indicated at block 302, glyph positioning of glyphs to be rendered is identified. Subsequently, at block 304, for a set of two or more glyphs, a determination is made as to whether to merge the glyphs for rendering as a set of merged glyphs. Such a determination might be made based on any number and manner of analysis, such as, for example, bounding box analysis or font analysis. In this regard, in one implementation, bounding boxes might be drawn around glyphs to determine whether the glyphs are within a threshold of one another. In another implementation, a set of font rules might be accessed to identify any applicable rules for the glyphs indicating whether or not the glyphs should be merged.

If it is determined to merge the glyphs, at block 306, the merged glyph set is rendered. On the other hand, if it is determined not to merge the glyphs, at block 308, for each glyph, it is determined whether a suitable representation of the glyph or corresponding glyph instance is in the hardware cache. As a glyph may be associated with multiple glyph instances in some embodiments, the appropriate glyph instance may be identified. If the glyph or glyph instance is in the hardware cache, at block 310, the corresponding glyph data in the hardware is used to render the glyph independently. If the glyph or glyph instance is not in the hardware cache, at block 312, appropriate glyph data is determined and cached. In this way, a glyph representation suitable for the given pixel position can be cached. At block 314, the corresponding glyph data in the hardware is used to independently render the glyph.

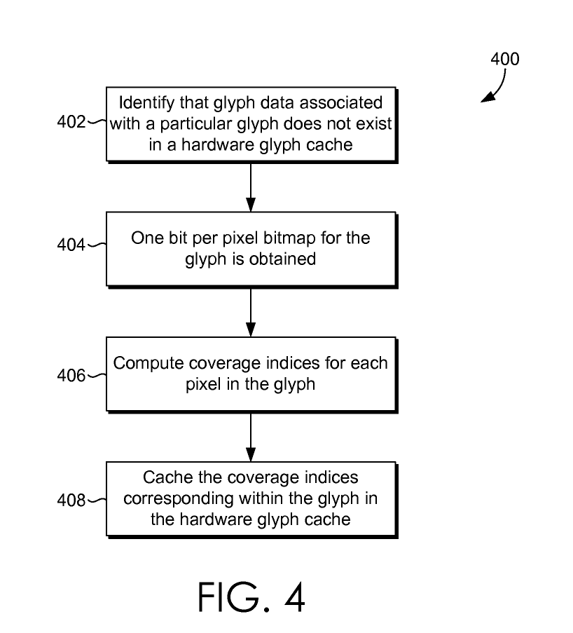

Turning now to FIG. 4, a first method 400 of caching glyphs in hardware is described, in accordance with an embodiment of the present invention. Method 400 may be performed by an individual glyph renderer component. Initially, as indicated at block 402, it is identified that glyph data associated with a particular glyph to be rendered does not exist in a hardware glyph cache. At block 404, one bit per pixel bitmap for the glyph is obtained. Such a bitmap might be obtained, for example, from a rasterization process. At block 406, coverage indices for each pixel in the glyph can be computed. Each coverage index associated with a pixel can be used to identify a pixel coverage for the given pixel for any of a range of multiple subpixel offsets. Thereafter, at block 408, the coverage indices corresponding with the glyph are cached in a hardware glyph cache. As such, the coverage indices can subsequently be referenced and utilized for subsequent renderings of the same glyph at any of a plurality of subpixel offsets.

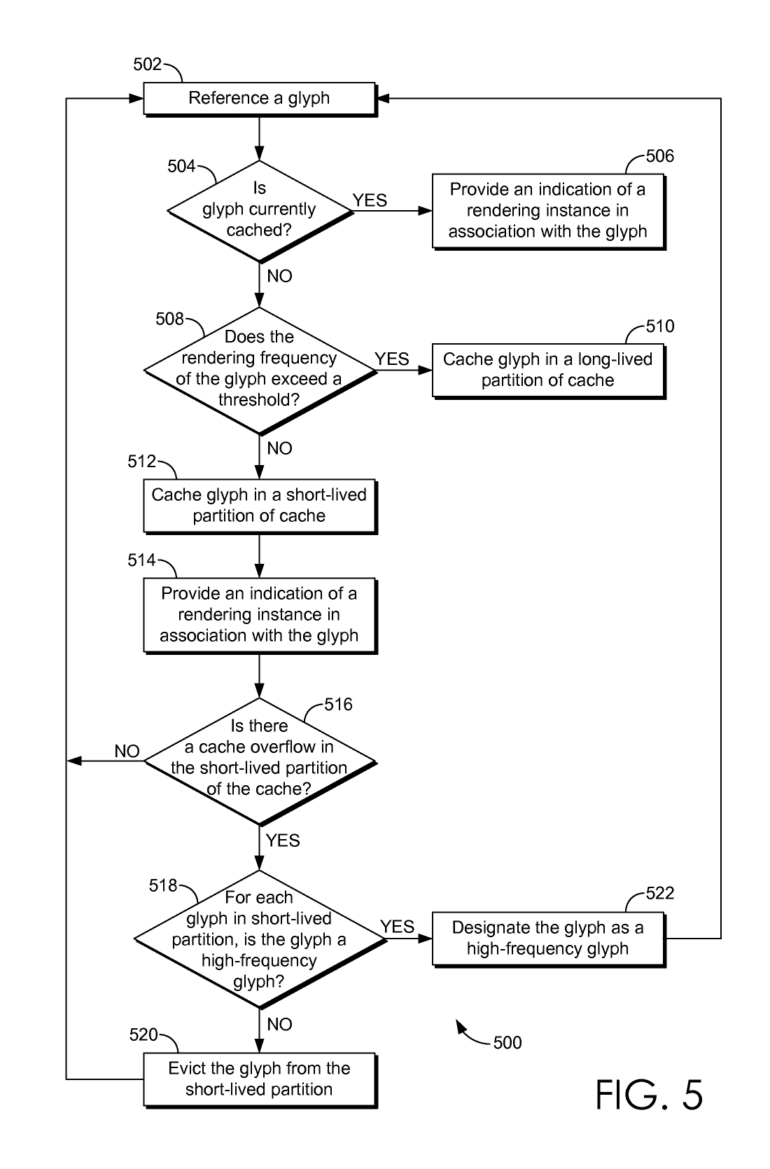

With respect to FIG. 5, a second method 500 of caching glyph data in hardware is described, in accordance with an embodiment of the present invention. Method 500 may be performed by an individual glyph renderer component. Initially, as indicated at block 502, a glyph is referenced. Thereafter, at block 504, it is determined if the glyph, or data associated therewith, is currently cached. Such a determination might be based on whether the glyph or glyph data is currently cached in the short-lived partition and/or the long-lived partition. If it is determined that the glyph or corresponding data is currently cached, an indication of a rendering instance is provided in association with the glyph, as indicated at block 506. Such a rendering indication enables tracking or usage of the glyph to facilitate identifying if/when the glyph might be provided to the long-lived partition.

On the other hand, if it is determined that the glyph or corresponding data is not currently cached, at block 508, it is determined if the rendering frequency of the glyph exceeds a threshold. If the rendering frequency of the glyph exceeds a threshold, glyph data is cached to the long-lived partition of the cache, as indicated at block 510. If, however, the rendering frequency of the glyph does not exceed a threshold, glyph data is cached to the short-lived partition of the cache, as indicated at block 512. Further, as indicated at 514, an indication of a rendering instance is provided in association with the glyph, for example, for tracking usage of the glyph.

At block 516, it is determined whether a cache overflow occurs in association with the short-lived partition of the cache. Such a cache overflow determination might be made based on whether the current rendering or the next rendering would fill the cache, for example. If it is determined that a cache overflow does not occur, methods 502-516 continue until such a cache overflow event occurs. On the other hand, if a cache overflow event occurs, a determination is made for each glyph as to whether the glyph is a high-frequency glyph, meaning that it has been rendered a sufficient number of times. This is indicated at block 518. For instance, glyphs rendered in excess of a high-frequency threshold (i.e., high-frequency renderings) are indicated or designated as high-frequency glyphs. If a glyph is not designated as a high-frequency glyph, the glyph data is evicted from the short-lived partition, as illustrated at block 520, and the method returns to block 502. In some cases, the glyph can be designated as a low-frequency glyph. If, however, the glyph is designated as a high-frequency glyph, the glyph is designated as a high-frequency glyph, as indicated at block 522, and the glyph can then be evicted from the short-lived partition. The method then returns to block 502. Although FIG. 5 is described herein in relation to whether a cache overflow occurs in association with the short-lived partition of the cache, a similar implementation can occur in relation to a cache overflow occurring in the long-lived partition.

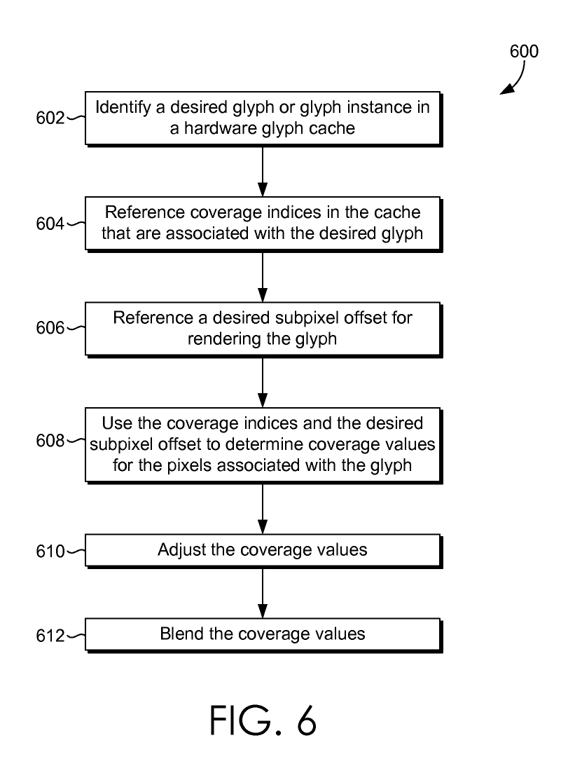

Turning now to FIG. 6, a method 600 of independently rendering a glyph using a glyph hardware cache. Method 600 may be performed, for example, by an individual glyph renderer component. Initially, as indicated at block 602, a desired glyph or glyph instance, or data associated therewith, is identified in a hardware glyph cache. As can be appreciated, in some embodiments, the glyph may be in a short-lived partition of the cache or a long-lived partition of the cache. As previously described, a particular glyph instance might be identified as available based on a desired subpixel position for positioning the glyph and a range of subpixel positions associated with the glyph instance. At block 604, coverage indices in the cache that are associated with the desired glyph are referenced. A desired subpixel offset for rendering the glyph is also referenced, as indicated at block 606. At block 608, the coverage indices and the desired subpixel offset are used to determine coverage values for the pixels associated with the glyph. In embodiments, a lookup table using the coverage indices and the desired subpixel offset can be used to lookup appropriate coverage values. Such a lookup table might be stored, for instance, in video memory such that it can be accessed directly by the GPU (e.g., in a same or separate resource from the coverage indices). At block 610, the coverage values are adjusted, and at block 612, the coverage values are blended.

The exemplary methods are illustrated as a collection of blocks in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be omitted from the methods without departing from the spirit and scope of the subject matter described herein. In the context of software, the blocks represent computer instructions that, when executed by one or more processors, perform the recited operations.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure. It will be understood that certain features and subcombinations are of utility and may be employed without reference to other features and subcombinations. This is contemplated by and is within the scope of the claims.

The invention claimed is:

1. One or more computer-storage media having computer-executable instructions embodied thereon for performing a method of facilitating caching glyph data in hardware, the method comprising:
referencing a first glyph and a second glyph;
determining whether to merge the first glyph and the second glyph for rendering together as a set of merged glyphs, wherein
when it is determined to merge the first glyph and the second glyph, the merged glyph set including the first glyph and the second glyph are rendered, and
when it is determined to render the first glyph and the second glyph separately, using glyph data associated with the first glyph that is in a hardware glyph cache and glyph data associated with the second glyph that is in the hardware glyph cache to render the first glyph and the second glyph separately.

2. The media of claim 1, wherein the hardware glyph cache comprises a video card memory.

3. The media of claim 1, wherein determining whether to merge the first glyph and the second glyph comprises utilizing a first bounding box positioned around the first glyph and a second bounding box positioned around the second glyph.

4. The media of claim 3, wherein the determination is made based on whether the first bounding box and the second bounding box are within a threshold distance from one another.

5. The media of claim 1, wherein determining whether to merge the first glyph and the second glyph comprises determining whether a first classification associated with the first glyph and a second classification associated with the second glyph are designated as a combination of classifications to be merged.

6. The media of claim 5, wherein the first classification and the second classification comprise an indication of capitalization of the corresponding glyph; an indication of a type of the corresponding glyph, an indication of a language of the corresponding glyph, an indication of a starting point for the corresponding glyph, an indication of an ending point for the corresponding glyph, or a combination thereof.

7. The media of claim 5, wherein the first classification and the second classification are associated with a font style used for the first glyph and the second glyph.

8. The media of claim 1, wherein the glyph data associated with the first glyph comprises a first set of coverage indices and the glyph data associated with the second glyph comprises a second set of coverage indices.

9. A method of facilitating caching glyph data, the method comprising:
in accordance with a determination that glyph data associated with a glyph to be rendered is not in a glyph cache, obtaining one bit per pixel bitmap for the glyph;
determining a coverage index for each pixel associated with the glyph, wherein each coverage index comprises a value that is used to identify a corresponding pixel coverage for any of a range of subpixel offsets; and
caching the coverage indices associated with the glyph in the glyph cache.

10. The method of claim 9, wherein the glyph cache comprises video card memory.

11. The method of claim 9, wherein the determination that glyph data associated with a glyph to be rendered is not in the glyph cache is based on glyph data not being present in a short-lived partition of the glyph cache or a long-lived partition of the glyph cache.

12. The method of claim 9, wherein the coverage indices are cached in a short-lived partition of the glyph cache when the glyph has been rendered a number of instances below a rendering threshold.

13. The method of claim 9, wherein the coverage indices are cached in a long-lived partition of the glyph cache when a frequency at which the coverage indices have been rendered is above a threshold amount.

14. The method of claim 9, wherein the cached coverage indices associated with the glyph are used to subsequently render the glyph.

15. The method of claim 14, wherein the cached coverage indices associated with the glyph are used with a desired subpixel offset for rendering the glyph to identify coverage values for each of the corresponding pixels.

16. The method of claim 9, wherein the cached coverage indices associated with the glyph are used to render the glyph at a first instance at a first subpixel offset and to render the glyph at a second instance at a second subpixel offset, wherein the first subpixel offset and the second subpixel offset are different from one another.

17. A method implemented on a graphical processing unit (GPU), the method comprising:
recognizing a desired glyph instance associated with a glyph in a hardware glyph cache;
referencing a set of coverage indices associated with the desired glyph instance, the set of coverage indices being cached in the hardware glyph cache; and
using the set of coverage indices and a desired subpixel offset for rendering the glyph to determine, via a computing device, coverage values for the pixels associated with the glyph.

18. The method of claim 17, wherein the desired glyph instance is identified by a computer processing unit and a location associated therewith is received by the graphical processing unit.

19. The method of claim 17, wherein the coverage values provide a depth of color, shade of color, or indication of color to be rendered for the corresponding pixel.

20. The method of claim 17, wherein each of the coverage indices comprises a value that is used to identify a corresponding pixel coverage for any of a range of subpixel offsets for rendering the glyph.
